(19) United States
(12) Patent Application Publication
(10) Pub. No.: US 2025/0271716 A1
(43) Pub. Date: Aug. 28, 2025

(54) ELECTRO-OPTICAL DEVICE AND ELECTRONIC APPARATUS

(71) Applicant: SEIKO EPSON CORPORATION, Tokyo (JP)

(72) Inventors: Shuji TERADA, MATSUMOTO-SHI (JP); Shogo TAKAHASHI, CHINO-SHI (JP); Masayuki WADA, NAGANO-SHI (JP)

(73) Assignee: SEIKO EPSON CORPORATION, Tokyo (JP)

(21) Appl. No.: 19/060,808

(22) Filed: Feb. 24, 2025

(30) Foreign Application Priority Data
Feb. 26, 2024 (JP) 2024-026439

(51) Int. Cl. G02F 1/1362; G02F 1/1343; G02F 1/1368

(52) U.S. Cl. CPC G02F 1/13629; G02F 1/134309; G02F 1/1368

(57) ABSTRACT

An electro-optical device includes a pixel electrode, a first wiring line including a first layer, a second layer, and a third layer, a transistor at least partially overlapping the first wiring line in plan view, and a data line provided in a layer between the first wiring line and the transistor, at least a portion of the data line overlapping the first wiring line in plan view, and electrically coupled to the pixel electrode via the transistor, in which the first layer has light reflectance and is disposed closer to the transistor than the second layer and the third layer, the second layer is provided between the first layer and the third layer and has light reflectance lower than the first layer, and the third layer has light reflectance higher than the second layer.

The present application is based on, and claims priority from JP Application Serial Number 2024-026439, filed Feb. 26, 2024, the disclosure of which is hereby incorporated by reference herein in its entirety.

### BACKGROUND

### 1. Technical Field

The present disclosure relates to an electro-optical device and an electronic apparatus.

### 2. Related Art

Typically, as one type of electro-optical device, an active-drive type liquid crystal device is known in which each pixel is provided with a transistor that controls switching of a pixel electrode. Such a liquid crystal device is provided with a contact hole used to couple various types of wiring lines or electrodes or the like. For example, JP-A-2005-242296 discloses an electro-optical device. This electro-optical device includes a contact hole used to couple a shield layer and a relay layer for the shield layer, and also includes a contact hole used to couple a third relay electrode and a second relay electrode.

In the electro-optical device disclosed in JP-A-2005-242296, when a stacked structure is adopted in the entire region of the contact hole, the shield layer, and the relay electrode, for example, a material having high light absorption efficiency such as titanium nitride may be used as an electrolytic corrosion prevention layer. However, when titanium nitride absorbs light, there is a problem that heat is likely to be generated inside a substrate.

### SUMMARY

In order to solve the above-mentioned problems, an electro-optical device according to an aspect of the present disclosure includes a pixel electrode, a first wiring line including a first layer, a second layer, and a third layer, a transistor at least partially overlapping the first wiring line in plan view, and a data line provided in a layer between the first wiring line and the transistor, at least a portion of the data line overlapping the first wiring line in plan view, and electrically coupled to the pixel electrode via the transistor, in which the first layer has light reflectance and is disposed closer to the transistor than the second layer and the third layer, the second layer is provided between the first layer and the third layer and has light reflectance lower than the first layer, and the third layer has light reflectance higher than the second layer.

An electronic apparatus according to another aspect of the present disclosure includes the electro-optical device according to the above-mentioned aspect.

### BRIEF DESCRIPTION OF THE DRAWINGS

FIG. 1 is a schematic plan view illustrating a configuration of a liquid crystal device according to a first embodiment.

FIG. 2 is a schematic cross-sectional view illustrating a structure of the liquid crystal device in a line segment A-A′ in FIG. 1.

FIG. 3 is an equivalent circuit diagram illustrating an electrical configuration of the liquid crystal device.

FIG. 4 is a schematic plan view illustrating the arrangement of pixels.

FIG. 5 is a cross-sectional view illustrating a structure of an element substrate in a line segment β1-β2 in FIG. 4.

FIG. 6 is a cross-sectional view illustrating a structure of an element substrate in a line segment α1-α2 in FIG. 4.

FIG. 7 is a cross-sectional view illustrating a structure of an element substrate in a line segment γ1-γ2 in FIG. 4.

FIG. 8 is a plan view illustrating a configuration of common wiring lines and third relay electrodes.

FIG. 9 is a plan view illustrating a mode of a third relay electrode according to a second embodiment.

FIG. 10 is a cross-sectional view illustrating a structure of an element substrate in a line segment β1-β2 in FIG. 4.

FIG. 11 is a cross-sectional view illustrating a structure of an element substrate in a line segment α1-α2 in FIG. 4.

FIG. 12 is a schematic view illustrating a configuration of a projection-type display device according to a third embodiment.

### DESCRIPTION OF EMBODIMENTS

Below, embodiments according to the present disclosure will be described with reference to the drawings. The present disclosure is not limited to the following embodiments. Various types of modification examples that are implemented are also included in the present disclosure within a range in which the main points of the present disclosure do not change.

In the following individual drawings, X, Y, and Z axes that represent coordinate axes perpendicular to each other are attached as necessary, and directions indicated by arrows are each set as the + direction, and directions opposite from the + direction are each set as the-direction. The +Z direction is also referred to as an upward side, and the −Z direction is also referred to as a downward side. In the present specification, a first direction represents a direction along the X-axis, and a second direction intersecting the first direction represents a direction along the Y-axis. In the following individual drawings, the scales of each layer and each member differ from those of actual layers and members in order to make each layer or each member have a recognizable size.

In addition, the plane including the X-axis and the Y-axis is also referred to as a XY plane, and a view of the XY plane as viewed from the +Z direction is also referred to as plan view or a planar view. Further, for example, with respect to a substrate, the expression “on the substrate” indicates any one of a case in which an object is disposed on the substrate in a contact manner, a case in which an object is indirectly disposed on the substrate with another structure being interposed therebetween, or a case in which a portion of an object is disposed on the substrate in a contact manner and a portion of the object is disposed with another structure being interposed therebetween.

### First Embodiment

As an example of an electro-optical device, the present embodiment describes an active-drive type liquid crystal device 100 including a thin film transistor (hereinafter referred to as a “TFT”) serving as a transistor and provided for each pixel. The liquid crystal device 100 is favorably used as an optical modulation element (liquid-crystal light valve) of a projection-type display device serving as an electronic apparatus that will be described later, for example.

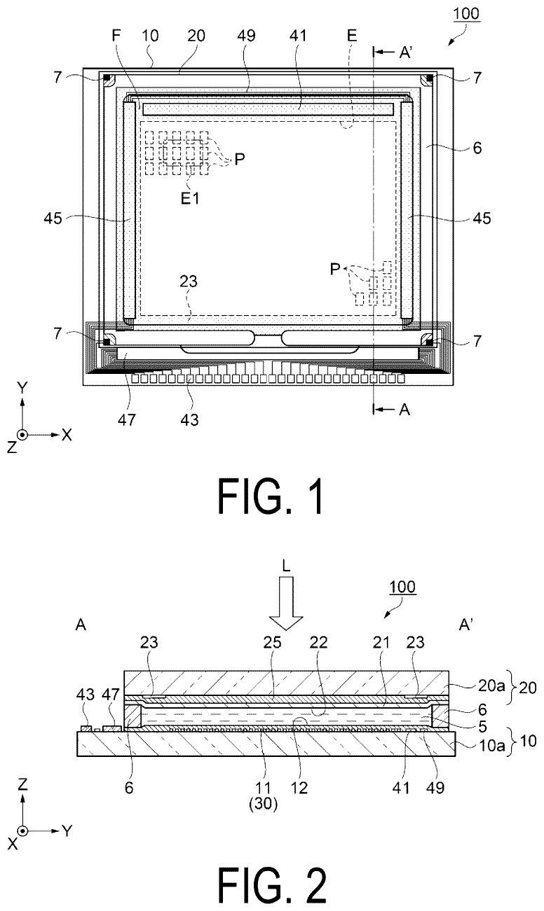

FIG. 1 is a schematic plan view illustrating a configuration of a liquid crystal device according to the present embodiment. FIG. 2 is a schematic cross-sectional view illustrating a structure of the liquid crystal device in a line segment A-A′ in FIG. 1.

As illustrated in FIGS. 1 and 2, the liquid crystal device 100 serving as an electro-optical device according to the present embodiment includes an element substrate 10, a counter substrate 20 disposed to be opposed to the element substrate 10, and a liquid crystal layer 5 including a liquid crystal interposed between the element substrate 10 and the counter substrate 20.

A substrate such as a glass substrate or a quartz substrate is used for a substrate 10a of the element substrate 10, for example. A transparent substrate such as a glass substrate or a quartz substrate is used for a substrate 20a of the counter substrate 20, for example.

The element substrate 10 is larger than the counter substrate 20 in plan view. The element substrate 10 and the counter substrate 20 are bonded together through a sealing material 6 disposed along the outer edge of the counter substrate 20. A liquid crystal having positive or negative dielectric anisotropy is incorporated in a space between the element substrate 10 and the counter substrate 20 to provide the liquid crystal layer 5. In the following description, the element substrate 10 and the counter substrate 20 are also referred to as a pair of substrates.

An adhesive such as thermosetting, light curable, electron-beam curable epoxy resin is used for the sealing material 6, for example. A spacer (not illustrated) is mixed with the sealing material 6 in order to maintain a constant distance between a pair of substrates.

A display region E including a plurality of pixels P arrayed in a matrix manner is provided at the inside of the sealing material 6. A peripheral area F is provided at the outside of the display region E. A partition portion 23 is provided in the peripheral area F and between the sealing material 6 and the display region E to surround the display region E. Metal or metallic oxide having a light shielding property is used for the partition portion 23.

Although not illustrated in the drawings, a dummy region is provided around the display region E, and a light shielding portion is provided in the display region E. The dummy region does not contribute to displaying performed by the liquid crystal device 100. The light shielding portion is a so-called black matrix, and is provided in the counter substrate 20.

A terminal portion in which a plurality of external coupling terminal 43 are arrayed is provided at the element substrate 10. A data-line drive circuit 47 is provided between the first side along the terminal portion and the sealing material 6. In addition, an inspection circuit 41 is provided between the display region E and the sealing material 6 along the second side opposed from the first side.

A scanning-line drive circuit 45 is provide between the display region E and the sealing material 6 along the third side and the fourth side that are perpendicular to the first side and are opposed to each other. A plurality of wiring lines 49 configured to couple two scanning-line drive circuits 45 are provided between the inspection circuit 41 and the sealing material 6 at the second side.

The data-line drive circuit 47 and the wiring lines 49 coupled to the scanning-line drive circuit 45 are electrically coupled to the plurality of external coupling terminals 43 arrayed along the first side. The arrangement of the inspection circuit 41 is not limited to that described above, and the inspection circuit 41 may be provided between the display region E and the sealing material 6 along the data-line drive circuit 47.

As illustrated in FIG. 2, a light-transmitting pixel electrode 11, a TFT 30 serving as a switching element, the wiring lines 49, and an alignment film 12 configured to cover these items are provided for each pixel P at the front surface, at the liquid crystal layer 5 side, of the substrate 10a. The TFT 30 and the pixel electrode 11 are constituent elements of the pixel P. The pixel electrode 11 is provided to correspond to the TFT 30. The element substrate 10 includes the substrate 10a, the pixel electrode 11 provided on the substrate 10a, the TFT 30, the wiring lines 49, and the alignment film 12.

Light L is incident on the liquid crystal device 100 from the counter substrate 20 side. The light L comes from a laser light source, for example. An incidence direction in which the light L is incident on the liquid crystal device 100 is not limited to the counter substrate 20 side, and the light L may be incident from the element substrate 10 side. In addition, the liquid crystal device 100 may be configured to include a light collecting unit such as a microlens configured to collect the incident light L for each pixel P.

At the front surface, at the liquid crystal layer 5 side, of the substrate 20a, there are provided the partition portion 23, an insulating layer 25 covering the partition portion 23 and formed into a film, a counter electrode 21 provided to cover the insulating layer 25, and an alignment film 22 provided to cover the counter electrode 21. The liquid crystal device 100 is configured such that a common electrode is disposed at the counter substrate 20 side as the counter electrode 21. However, the liquid crystal device 100 is not limited to this configuration.

As illustrated in FIG. 1, the scanning-line drive circuit 45 and the inspection circuit 41 overlap the partition portion 23 in plan view. The partition portion 23 functions as a light shielding portion. Specifically, the partition portion 23 blocks light such that the light L described above incident from the counter substrate 20 side is not incident on a peripheral circuit such as the scanning-line drive circuit 45. That is, the partition portion 23 has a function of preventing a malfunction of peripheral circuits. In addition, the partition portion 23 also curbs incidence of unnecessary stray light on the display region E. This makes it possible to curb a reduction in the contrast of the liquid crystal device 100.

With reference back to FIG. 2, the insulating layer 25 is configured to cover the partition portion 23 and is provided to flatten the front surface of the liquid crystal layer 5 side. The insulating layer 25 is made of an inorganic material such as silicon oxide having light transmittance, for example.

The counter electrode 21 is configured to cover the insulating layer 25, and is electrically coupled to an up-down conductive portion 7 provided at four corners of the counter substrate 20. The up-down conductive portion 7 is electrically coupled to a common wiring line 18, which will be described later, at the element substrate 10 side.

The pixel electrode 11 and the counter electrode 21 are configured with a transparent conductive film made of indium tin oxide (ITO), indium zinc oxide (IZO), or the like, for example. The alignment film 12 and the alignment film 22 are selected on the basis of optical design of the liquid crystal device 100. The material of the alignment films 12 and 22 includes an inorganic alignment film made of silicon oxide or the like and an organic alignment film made of polyimide or the like.

The optical design of a normally white mode or normally black mode is employed for the liquid crystal device 100. In the normally white mode, the transmittance of a pixel P when no voltage is applied is larger than the transmittance when a voltage is applied. In the normally black mode, the transmittance of a pixel P when no voltage is applied is smaller than the transmittance when a voltage is applied. In the liquid crystal device 100, a polarizing element is disposed at each of the side on which the light L is incident and the side from which the light L is emitted, depending on the optical design.

The present embodiment describes an example in which the inorganic alignment film described above is used as the alignment films 12 and 22, a liquid crystal having negative dielectric anisotropy is used, and the optical design of the normally black mode is employed.

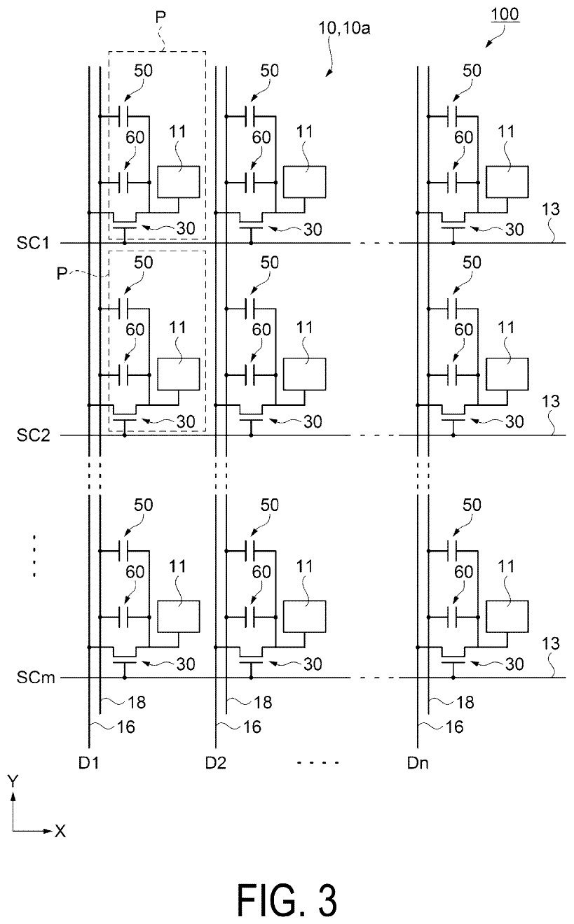

FIG. 3 is an equivalent circuit diagram illustrating an electrical configuration of the liquid crystal apparatus.

As illustrated in FIG. 3, the liquid crystal device 100 includes a scanning line 13, a data line 16, and a common wiring line 18 provided on the substrate 10a of the element substrate 10. The scanning line 13 extends along the X-axis. The data line 16 and the common wiring line 18 extend along the Y-axis. The common wiring line 18 is not limited to that extending along the Y-axis. The common wiring line 18 is an example of a first wiring line of the present disclosure.

A region separated by the scanning line 13 extending along the X-axis and the data line 16 extending along the Y-axis is a pixel P. The pixel P includes the pixel electrode 11, the TFT 30, a first capacitance element 50, and a second capacitance element 60. The first capacitance element 50 and the second capacitance element 60 are provided to correspond to the pixel electrode 11.

The scanning line 13 is electrically coupled to the gate of the TFT 30. The data line 16 is electrically coupled to the source of the TFT 30. The scanning line 13 has a function of collectively controlling turning on and off the TFT 30 provided in the same row. The pixel electrode 11 is electrically coupled to the drain of the TFT 30.

The data line 16 is electrically coupled to the data-line drive circuit 47, and supplies the pixel P with image signals D1, D2, . . . , and Dn supplied from the data-line drive circuit 47. The scanning line 13 is electrically coupled to the scanning-line drive circuit 45, and supplies each pixel P with scanning signals SC1, SC2, . . . , and SCm supplied from the scanning-line drive circuit 45.

The image signal D1 to the image signal Dn supplied from the data-line drive circuit 47 to the data line 16 may be supplied in a line-sequential manner in this order, or may be supplied, on a group-by-group basis, to a plurality of data lines 16 adjacent to each other. The scanning-line drive circuit 45 supplies the scanning line 13 with the scanning signal SC1 to the scanning signal SCm at a predetermined timing in a pulse form in a line-sequential manner.

When the scanning signal SC1 is input to the TFT 30, the TFT 30 is brought into the ON state for a predetermined period of time. Thereby, the image signal D1 supplied from the data line 16 is written in the pixel electrode 11 at a predetermined timing. In addition, the image signal DI at a predetermined level written in the liquid crystal layer 5 through the pixel electrode 11 is held for a certain period of time between the pixel electrode 11 and the counter electrode 21 disposed to be opposed to each other with the liquid crystal layer 5 being interposed between them.

In order to prevent the held image signal D1 from leaking, the first capacitance element 50 and the second capacitance element 60 are electrically coupled in parallel with respect to a liquid crystal capacitor provided between the pixel electrode 11 and the counter electrode 21. One end of the first capacitance element 50 is electrically coupled to the drain of the TFT 30 and the pixel electrode 11. The other end of the first capacitance element 50 is electrically coupled to the common wiring line 18 to which a constant potential is applied. Similarly to the first capacitance element 50, the second capacitance element 60 is electrically coupled to the common wiring line 18.

Here, although not illustrated in the drawings, the inspection circuit 41 is coupled to the data line 16. During the process of manufacturing the liquid crystal device 100, this makes it possible to detect the image signals D1, D2, . . . , and Dn to confirm operational malfunction or the like of the liquid crystal device 100.

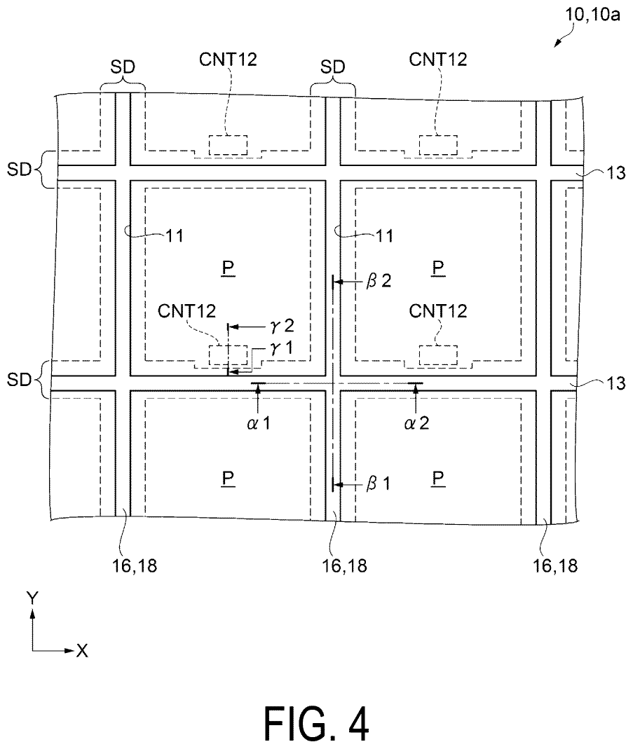

FIG. 4 is a schematic plan view illustrating arrangement of pixels.

As illustrated in FIG. 4, the pixel electrode 11 has a substantially square shape, and there are a plurality of pixel electrodes 11 provided in a matrix manner to correspond to the arrangement of pixels P. Between adjacent pixel electrodes 11, the scanning line 13 is provided along the X-axis, and the data line 16 and the common wiring line 18 are provided along the Y-axis. In FIG. 4, illustration is made such that a region E1 that is a portion of the display region E in FIG. 1 is enlarged.

In the display region E, a plurality of pixels P are divided in plan view to provide a light shielding region SD. The light shielding region SD includes a straight-shaped portion including the scanning line 13, and a straight-shaped portion including the data line 16 and the common wiring line 18, and has a lattice shape as shown by a dashed line. An electrically conductive member having a light shielding property is used for the functional layers and wiring lines such as the scanning line 13 and the data line 16, and hence, the light shielding region SD is a so-called non-open area. That is, in the display region E, a region except for the light shielding region SD is an opening area.

A second contact hole CNT12 is provided in an end portion, at the −Y direction, of the light shielding region SD so as to correspond to the pixel electrode 11. The pixel electrode 11 and a third relay electrode 83 that will be described later are electrically coupled to each other through the second contact hole CNT12. That is, in the present embodiment, the third relay electrode 83 corresponds to a third relay electrode of a typical electro-optical device.

In the liquid crystal device 100, the second contact hole CNT12 is provided in the light shielding region SD. That is, the scanning line 13 and the common wiring line 18 are not recessed in plan view, and hence, it is possible to further reduce the width of these wiring lines, which makes it possible to easily improve the aperture ratio. Detailed configuration of the element substrate 10 including the third relay electrode 83 and the like will be described later.

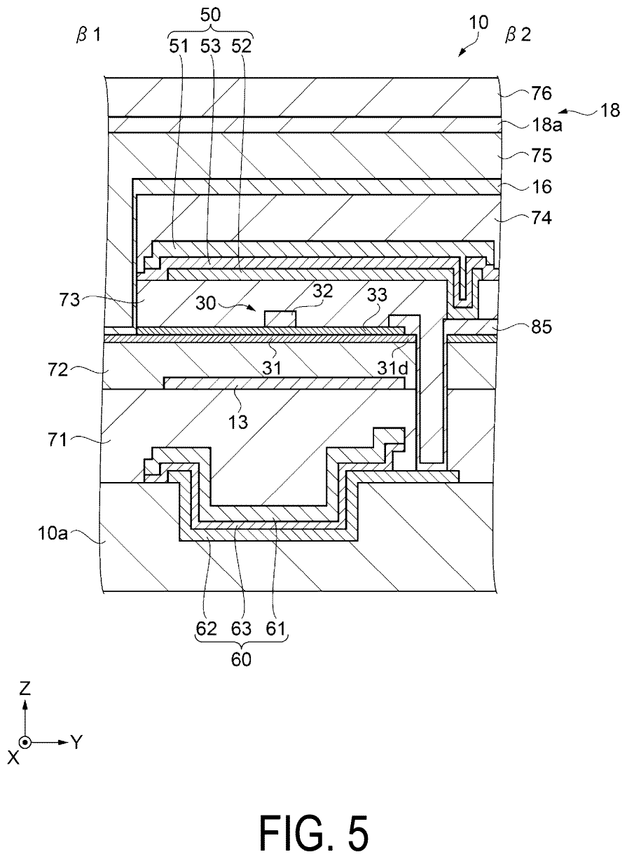

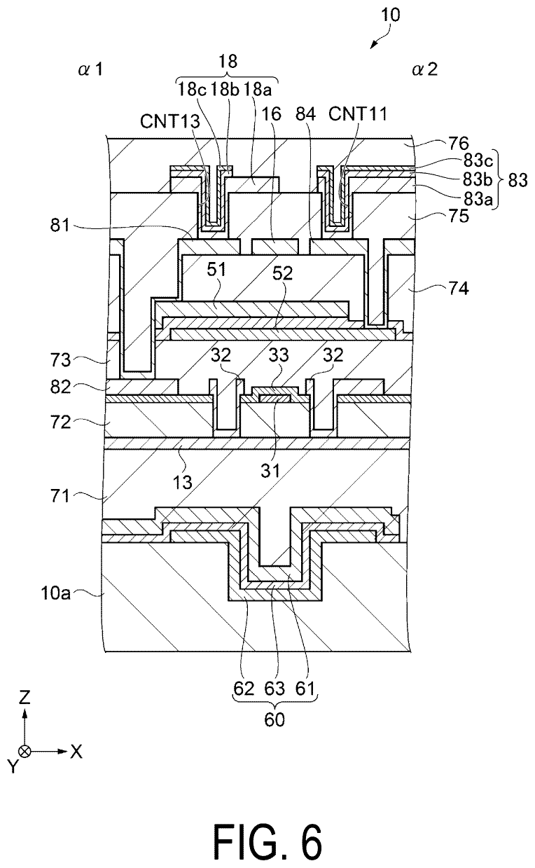

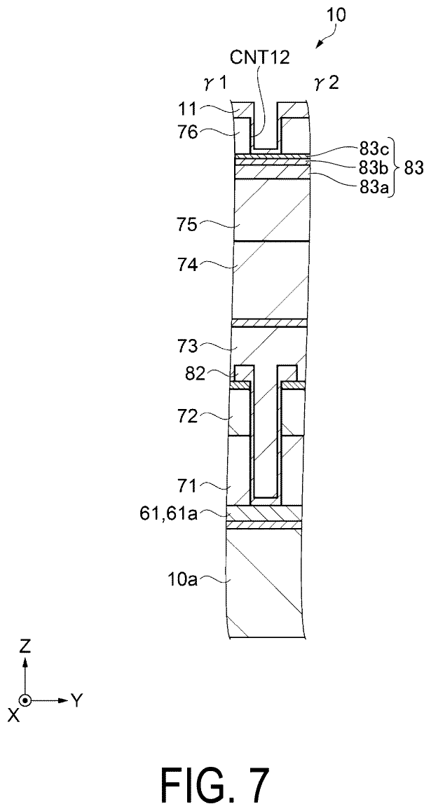

FIG. 5 is a cross-sectional view illustrating a structure of an element substrate in a line segment β1-β2 in FIG. 4. FIG. 6 is a cross-sectional view illustrating a structure of an element substrate in a line segment α1-α2 in FIG. 4. FIG. 7 is a cross-sectional view illustrating a structure of an element substrate in a line segment γ1-γ2 in FIG. 4.

As illustrated in FIGS. 5, 6, and 7, the element substrate 10 of the liquid crystal device 100 includes the substrate 10a, the second capacitance element 60, the scanning line 13, the TFT 30 including a semiconductor layer 31 and a gate electrode 32, the first capacitance element 50, the data line 16, the common wiring line 18, the third relay electrode 83, the pixel electrode 11, and a plurality of interlayer insulating layers that will be described later. The third relay electrode 83 is an example of a relay layer of the present disclosure.

The element substrate 10 has a configuration in which a plurality of functional layers are stacked on the substrate 10a serving as a base. Specifically, on the substrate 10a, there are stacked, in this order, a first conductive layer including a fourth capacitance electrode 62 of the second capacitance element 60, a second conductive layer including a third capacitance electrode 61 of the second capacitance element 60, a third conductive layer including the scanning line 13, a fourth conductive layer including the semiconductor layer 31 of the TFT 30 and the gate electrode 32 of the TFT 30, a fifth conductive layer including a second capacitance electrode 52 of the first capacitance element 50, a sixth conductive layer including a first capacitance electrode 51 of the first capacitance element 50, a seventh conductive layer including the data line 16, an eighth conductive layer including the common wiring line 18, and the pixel electrode 11.

A second dielectric layer 63 is provided between the fourth capacitance electrode 62 of the second capacitance element 60, which is the first conductive layer, and the third capacitance electrode 61 of the second capacitance element 60, which is the second conductive layer. A first interlayer insulating layer 71 is provided between the second conductive layer and the scanning line 13 which is the third conductive layer. A second interlayer insulating layer 72 is provided between the third conductive layer and the semiconductor layer 31 of the TFT 30. A gate insulating layer 33 is provided between the semiconductor layer 31 and the gate electrode 32. A third interlayer insulating layer 73 serving as a second insulating layer is provided between the TFT 30, which is the fourth conductive layer, and the second capacitance electrode 52 of the first capacitance element 50, which is the fifth conductive layer.

A first dielectric layer 53 is provided between the second capacitance electrode 52 of the first capacitance element 50, which is the fifth conductive layer, and the first capacitance electrode 51 of the first capacitance element 50, which is the sixth conductive layer. A fourth interlayer insulating layer 74 serving as a first insulating layer is provided between the first capacitance electrode 51, which is the sixth conductive layer, and the data line 16, which is the seventh conductive layer. A fifth interlayer insulating layer 75 is provided between the data line 16, which is the seventh conductive layer, and the common wiring line 18, which is the eighth conductive layer. A sixth interlayer insulating layer 76 is provided between the common wiring line 18, which is the eighth conductive layer, and the pixel electrode 11.

The materials of these interlayer insulating layers include silicon oxide (None-doped Silicate Glass: NSG) or silicon nitride or the like, for example. In the present embodiment, silicon oxide is employed.

The second capacitance element 60 is provided on the substrate 10a and also inside of a trench that is not illustrated in the drawing. The second capacitance element 60 is configured such that the fourth capacitance electrode 62, the second dielectric layer 63, and the third capacitance electrode 61 are stacked in the order from the substrate 10a side. The materials of the third capacitance electrode 61 and the fourth capacitance electrode 62 include electrically conductive polysilicon, for example. A dielectric material is used for the material of the second dielectric layer 63. For example, the dielectric material includes silicon nitride, silicon oxide, hafnium oxide, aluminum oxide, tantalum oxide, or the like, and these layers are used as a single layer or as a combination of them.

The scanning line 13 also functions as a light shielding layer, and is provided on the first interlayer insulating layer 71. A known material having a light shielding property and electrically conductive property is used for the scanning line 13. The scanning line 13 has a function of blocking the light L incident on the semiconductor layer 31 mainly from below. In the present embodiment, tungsten silicide is used as the material of the scanning line 13.

The TFT 30 includes the semiconductor layer 31 provided on the second interlayer insulating layer 72, the gate insulating layer 33, and the gate electrode 32 provided on the third interlayer insulating layer 73. The gate electrode 32 is electrically coupled to the scanning line 13.

The semiconductor layer 31 of the TFT 30 is provided with a lightly doped drain (LDD) structure. The semiconductor layer 31 is made of conductive polysilicon, for example. The gate electrode 32 is made of conductive polysilicon, for example. The semiconductor layer 31 extends along the Y-axis.

The first capacitance element 50 is provided on the third interlayer insulating layer 73. The first capacitance element 50 is configured such that the second capacitance electrode 52, the first dielectric layer 53, and the first capacitance electrode 51 are stacked in the order from the substrate 10a side. The materials of the first capacitance electrode 51 and the second capacitance electrode 52 include electrically conductive polysilicon, for example. A dielectric material similar to that of the second capacitance element 60 is used as the material of the first dielectric layer 53.

The data line 16 is provided on the fourth interlayer insulating layer 74, and extends along the Y-axis. There is no particular limitation as to the material of the data line 16 as long as the material is a low-resistance wiring line material having electrical conductivity, and the material of the data line 16 includes a metal such as aluminum or titanium, or a metallic compound of these metal, for example. The data line 16 is electrically coupled to a source-drain region of the semiconductor layer 31.

The common wiring line 18 and the third relay electrode 83 are provided in the same layer at the fifth interlayer insulating layer 75. The common wiring line 18 and the third relay electrode 83 are electrically coupled to the counter electrode 21 described above, and are supplied with a common potential. The materials of the common wiring line 18 and the third relay electrode 83 include a metal such as aluminum or titanium, or a metallic compound of these metals, for example. In the liquid crystal device 100, a stacked structure is employed for the common wiring line 18 and the third relay electrode 83.

Specifically, the common wiring line 18 includes a first layer 18a having light reflectance, a second layer 18b stacked on the first layer 18a and having light reflectance lower than the first layer 18a, and a third layer 18c staked on the second layer 18b and having light reflectance higher than the second layer 18b. The third relay electrode 83 includes a first layer 83a having light reflectance, a second layer 83b stacked on the first layer 83a and having light reflectance lower than the first layer 83a, and a third layer 83c stacked on the second layer 83b and having light reflectance higher than the second layer 83b.

The first layers 18a and 83a contain aluminum, the second layers 18b and 83b contain titanium nitride., and the third layers 18c and 83c contain titanium. Specifically, in the present embodiment, aluminum is adopted for the first layers 18a and 83a, titanium nitride is adopted for the second layers 18b and 83b, and titanium is adopted for the third layers 18c and 83c. The titanium nitride used in the second layers 18b and 83b exerts effect of curbing electrolytic corrosion and oxidation of the aluminum in the first layers 18a and 83a and protecting the first layers 18a and 83a from a stripping solution used in a patterning process during manufacturing. On the other hand, aluminum has favorable electrical conductivity, has light reflectance higher than titanium nitride, and exerts effect of reflecting light L by not providing the second layers 18b and 83b in a region that does not require the above-mentioned effect to curb generation of heat within the element substrate 10. In addition, titanium has light reflectance higher than titanium nitride, and exerts effect of reflecting light L in a region that requires the above-mentioned effect the second layers 18b and 83b by disposing titanium on the second layers 18b and 83b in an overlapping manner to efficiently curb heat generation inside the element substrate 10.

Here, when the films are formed using a sputtering method, the light reflectance of aluminum is approximately 90% in a wavelength of 550 nm in a visible range, the light reflectance of titanium nitride is approximately 25%, and the light reflectance of titanium is approximately 55%, for example. The light reflectance of such a base material can be measured using a spectro photometer or the like. In the present specification, the “having light reflectance” means that the light reflectance described above is approximately 50% or more. With this configuration, by actively reflecting light to prevent light absorption, it is possible to curb heat generation inside the liquid crystal device 100.

In the present embodiment, the areas of the third layers 18c and 83c are equal to the areas of the second layers 18b and 83b in plan view. When the element substrate 10 is seen in plan view, the areas of the third layers 18c and 83c that cover the second layers 18b and 83b are smaller than the areas of the corresponding first layers 18a and 83a. That is, the second layers 18b and 83b and the third layers 18c and 83c are stacked at a portion of the region of the corresponding first layers 18a and 83a, rather than being stacked in the entire regions of the first layers 18a and 83a. Details of the common wiring line 18 and the third relay electrode 83 will be described later.

The pixel electrode 11 is provided on the sixth interlayer insulating layer 76. Although not illustrated in the drawings, the alignment film 12 is provided to cover the pixel electrode 11. The alignment film 12 of the element substrate 10 and the alignment film 22 and the counter substrate 20 described above are each configured with a collective body of columns obtained by depositing an inorganic material such as silicon oxide from a predetermined direction such as an oblique direction and growing the inorganic material into a column shape.

As illustrated in FIG. 5, the second capacitance electrode 52 of the first capacitance element 50 is electrically coupled to a fifth relay electrode 85 disposed at the fourth conductive layer, and the fifth relay electrode 85 is electrically coupled to the fourth capacitance electrode 62 of the second capacitance element 60.

The second layer 18b and the third layer 18c are not provided in a range of the line segment β1-β2 of the common wiring line 18. The light L incident from above is reflected by the first layer 18a in a region where the second layer 18b and the third layer 18c are not stacked. Thus, in this region described above, it is possible to curb generation of heat due to absorption of the light L.

As illustrated in FIG. 6, the common wiring line 18 and the first capacitance electrode 51 of the first capacitance element 50 are electrically coupled through a first relay electrode 81 disposed in the seventh conductive layer. Furthermore, the first relay electrode 81 is electrically coupled to a second relay electrode 82 disposed in the fourth conductive layer.

The third relay electrode 83 is electrically coupled to a fourth relay electrode 84 disposed in the seventh conductive layer. The fourth relay electrode 84 is electrically coupled to the second capacitance electrode 52 of the first capacitance element 50.

The third relay electrode 83 is formed to extend into a first contact hole CNT11 in a region overlapping the first contact hole CNT11. The first layer 83a, the second layer 83b, and the third layer 83c are provided along the inner surface of the first contact hole CNT11. More specifically, the first layer 83a is routed along the inner surface of the first contact hole CNT11 and is electrically coupled to the fourth relay electrode 84 located on the bottom surface of the first contact hole CNT11. The second layer 83b is disposed along the surface of the first layer 83a, and the third layer 83c is disposed along the surface of the second layer 83b, and thus disposed along the inner surface of the first contact hole CNT11.

The aluminum that constitutes the first layer 83a of the third relay electrode 83 is easily etched using a stripping solution for a resist film used in a patterning process. The first layer 83a tends to have poor adhesion inside the contact hole and to have a thin film thickness. For this reason, when the first layer 83a is etched, there is a concern that the reliability of electrical coupling will be reduced.

In contrast, in the case of the present embodiment, the first layer 83a is covered and protected by the second layer 83b and the third layer 83c in the process of patterning the third relay electrode 83, and thus etching of the first layer 83a is curbed and the reliability of electrical coupling is improved.

As illustrated in FIGS. 6 and 7, the first capacitance electrode 51 of the first capacitance element 50 and the third capacitance electrode 61 of the second capacitance element 60 are electrically coupled to the common wiring line 18 through the first relay electrode 81 disposed in the seventh conductive layer and the second relay electrode 82 disposed in the fourth conductive layer.

The common wiring line 18 is provided to extend into a third contact hole CNT13 in a region overlapping the third contact hole CNT13. The first layer 18a, the second layer 18b and the third layer 18c are provided along the inner surface of the third contact hole CNT13. More specifically, the first layer 18a is routed along the inner surface of the third contact hole CNT13 and is electrically coupled to the first relay electrode 81 located on the bottom surface of the third contact hole CNT13. The second layer 18b is disposed along the surface of the first layer 18a, and the third layer 18c is disposed along the surface of the second layer 18b, and thus is disposed along the inner surface of the third contact hole CNT13.

Aluminum constituting the first layer 18a of the common wiring line 18 is easily etched using a stripping solution for a resist film used in a patterning process. The first layer 18a tends to have poor adhesion inside the contact hole and to have a thin film thickness. For this reason, when the first layer 18a is etched, there is a concern that the reliability of electrical coupling will be reduced.

In contrast, in the case of the present embodiment, the first layer 18a is covered and protected by the second layer 18b and the third layer 18c in the process of patterning the common wiring line 18, and thus etching of the first layer 18a is curbed and the reliability of electrical coupling is improved.

As illustrated in FIG. 7, the second relay electrode 82 is electrically coupled to the third capacitance electrode 61 of the second capacitance element 60. Specifically, although not illustrated in the drawings, the third capacitance electrode 61 includes a sticking-out portion 61a that sticks out in plan view. The second relay electrode 82 is electrically coupled to this sticking-out portion 61a. The second capacitance electrode 52 of the first capacitance element 50 and the fourth capacitance electrode 62 of the second capacitance element 60 are electrically coupled to the pixel electrode 11 and a drain 31d of the TFT 30. Instead of the first capacitance element 50, it may be possible to use a relay electrode used to electrically couple the fourth capacitance electrode 62 of the second capacitance element 60 and the drain 31d of the TFT 30.

The pixel electrode 11 is electrically coupled to the third relay electrode 83 disposed in the eighth conductive layer. In particular, the pixel electrode 11 is electrically coupled to the third relay electrode 83 through the second contact hole CNT12. In the third relay electrode 83, the second layer 83b and the third layer 83c are covered on the first layer 83a in a region including the region where the third relay electrode 83 overlaps the second contact hole CNT12. In the case of the present embodiment, the second layer 83b covers the first layer 83a, and the third layer 83c covers the second layer 83b. That is, the second layer 83b and the third layer 83c are interposed between the pixel electrode 11 and the first layer 83a.

Here, when aluminum and ITO are electrically coupled directly to each other, electrolytic corrosion is more likely to occur between them. This may lead to breakage of aluminum lines or insulation due to generation of alumina or the like. In contrast, in the present embodiment, titanium and ITO are coupled, which curbs the occurrence of electrolytic corrosion in the region including the second contact hole CNT12, improving the reliability of electrical coupling. Only the second layer 83b may be covered on the first layer 83a. Even in this case, the coupling between titanium nitride and ITO curbs the occurrence of electrolytic corrosion, improving the reliability of electrical coupling.

The signal wiring lines such as scanning line 13 and the common wiring line 18 that constitute the functional layers described above and the electrodes such as the TFT 30 and the first relay electrode 81 are provided in the light shielding region SD that separates a plurality of pixels P in plan view.

In manufacturing of the element substrate 10, it may be possible to employ a known method applied to known semiconductor processes, which includes a low pressure chemical vapor deposition (CVD) method, an atmospheric pressure CVD method, a plasma CVD method, a photolithography method, a sputtering method, an etching method, a chemical mechanical planarization (CMP) method, and the like.

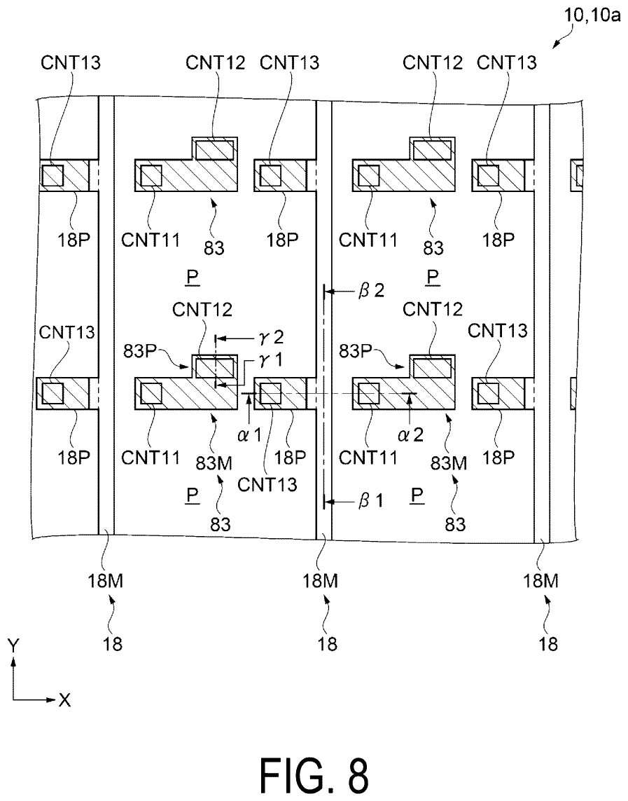

FIG. 8 is a plan view illustrating configurations of common wiring lines and third relay electrodes.

As illustrated in FIG. 8, common wiring lines 18 are disposed along the Y-axis in a stripe manner. The element substrate 10 includes a common wiring line 18 serving as a first wiring line at the center in FIG. 8, and a common wiring line 18 serving as a second wiring line adjacent in a direction along the X-axis. The third relay electrode 83 is provided between common wiring lines 18 adjacent to each other in plan view. Thereby, the common wiring lines 18 and the third relay electrode 83 can be disposed in a state of being separated from each other.

FIG. 8 illustrates a region corresponding to FIG. 4. Additionally, in the common wiring line 18, the region to which the stacked structure configured with the first layer 18a, the second layer 18b, and the third layer 18c is applied is indicated by hatching. Similarly, also in the third relay electrode 83, the region to which the stacked structure configured with the first layer 83a, the second layer 83b, and the third layer 83c is applied is indicated by hatching. Furthermore, the boundary between a main body portion 18M and a protruding portion 18P, which will be described later, is shown by a dashed line.

The common wiring line 18 includes the main body portion 18M and the protruding portion 18P. The main body portion 18M extends in a direction along the Y-axis. The protruding portion 18P protrudes from the main body portion 18M in the −X direction. The main body portion 18M and the protruding portion 18P are examples of a second main body portion and a second protruding portion of the present disclosure.

The protruding portion 18P is configured such that the first layer 18a and the second layer 18b are provided in a region including a region that overlaps the third contact hole CNT13 in plan view. Specifically, the protruding portion 18P is configured such that the third contact hole CNT13 is disposed in a region including a region that overlaps, in plan view, the vicinity of the end portion at the −X direction of the protruding portion 18P.

The common wiring line 18 is electrically coupled to the first capacitance electrode 51 of the first capacitance element 50 described above through the third contact hole CNT13.

The second layer 18b and the third layer 18c are not provided at at least a portion of the main body portion 18M. That is, in the present embodiment, the second layer 18b and the third layer 18c are not provided over the entire region of the main body portion 18M in plan view. In addition, the protruding portion 18P is configured such that the second layer 18b and the third layer 18c are not provided at a portion in the +X direction which is the common wiring line 18 side.

The arrangement described above is preferable when the distance between adjacent common wiring lines 18 along the X-axis is relatively wide. That is, since the above-mentioned distance is relatively wide, the functions of the second layer 18b and the third layer 18c are sufficiently exerted around the third contact hole CNT13 even when the areas of the second layer 18b and the third layer 18c are relatively small. Thereby, the surplus second layer 18b and third layer 18c around the third contact hole CNT13 are reduced. For this reason, the region where the first layer 18a is exposed is increased, further curbing heat generation inside the element substrate 10, while improving the reliability of electrical coupling around the third contact hole CNT13.

The third relay electrode 83 includes a main body portion 83M and a protruding portion 83P. The main body portion 83M has an island shape, and extends in a direction along the X-axis. The protruding portion 83P protrudes from the main body portion 83M in the +Y direction. The main body portion 83M and the protruding portion 83P are examples of a first main body portion and a first protruding portion of the present disclosure.

The third relay electrode 83 is configured such that the first layer 83a, the second layer 83b, and the third layer 83c are provided in a region including a region that overlaps the first contact hole CNT11 and the second contact hole CNT12 in plan view. Specifically, in the main body portion 83M, the first contact hole CNT11 is disposed in a region including a region that overlaps the end portion at the −X direction and the vicinity of this end portion in plan view. The second contact hole CNT12 is disposed in a region including a region that overlaps the protruding portion 83P in plan view. In the third relay electrode 83, the entire region of the first layer 83a is covered with the second layer 83b and the third layer 83c in plan view.

The protruding portion 83P is electrically coupled to the pixel electrode 11 described above through the second contact hole CNT12. The main body portion 83M is electrically coupled to the TFT 30 described above through the first contact hole CNT11.

The first layers 18a and 83a, the second layers 18b and 83b, and the third layers 18c and 83c can be formed by a known technique such as sputtering. In the direction along the Z-axis, the first layers 18a and 83a have a thickness of, for example, 0.35 μm, the second layers 18b and 83b have a thickness of, for example, 0.13 μm, and the third layers 18c and 83c have a thickness of, for example, 0.02 μm.

According to the liquid crystal device 100 of the present embodiment, the following effects can be obtained.

According to the liquid crystal device 100 of the present embodiment, an aperture ratio and the reliability of the electrical couplings in the first contact hole CNT11, the second contact hole CNT12, and the third contact hole CNT13 are improved, and heat generation inside the element substrate 10 can be curbed. More specifically, the third relay electrode 83 and the pixel electrode 11 are electrically coupled by the second contact hole CNT12 that is disposed in a region including the region that overlaps the protruding portion 83P in plan view. This configuration makes it possible to reduce the width and the area of the main body portion 83M in plan view, as compared with a case in which the second contact hole CNT12 is disposed in a region including a region that overlaps the main body portion 83M of the third relay electrode 83 in plan view. This makes it possible to improve the aperture ratio.

Since the protruding portions 18P and 83P have a stacked structure of aluminum, titanium nitride, and titanium, the first contact hole CNT11 and the third contact hole CNT13 also have a stacked structure in which aluminum, titanium nitride, and titanium are stacked. For this reason, when the third relay electrode 83 and the common wiring line 18 are patterned, the first layers 18a and 83a are protected by the second layers 18b and 83b and the third layers 18c and 83c, and etching of the first layers 18a and 83a is curbed. This makes it possible to improve the reliability of electrical coupling through the first contact hole CNT11 and the third contact hole CNT13.

The third layer 18c covering the outermost surface of the common wiring line 18 easily reflects light L, thereby curbing heat generation inside the element substrate 10 due to absorption of the light L in the common wiring line 18. Furthermore, the second layer 18b and the third layer 18c are not provided in at least a portion of the region of the common wiring line 18, that is, portions of the regions of the main body portion 18M and the protruding portion 18P. The first layer 18a easily reflects light L compared to the second layer 18b and the third layer 18c, thereby curbing heat generation inside the element substrate 10 due to absorption of the light L. Thus, it is possible to curb heat generation in the liquid crystal device 100.

The second contact hole CNT12 is provided in a region that overlaps the protruding portion 83P of the third relay electrode 83 having the stacked structure. For this reason, since the second layer 83b and the third layer 83c are interposed between the first layer 83a and the pixel electrode 11, it is possible to curb the occurrence of electrolytic corrosion and improve the reliability of electrical coupling.

As described above, according to the present embodiment, it is possible to provide the liquid crystal device 100 that improves an aperture ratio and the reliability of electrical coupling between the first contact hole CNT11 and the third contact hole CNT13, and curbs heat generation inside the element substrate 10.

### Second Embodiment

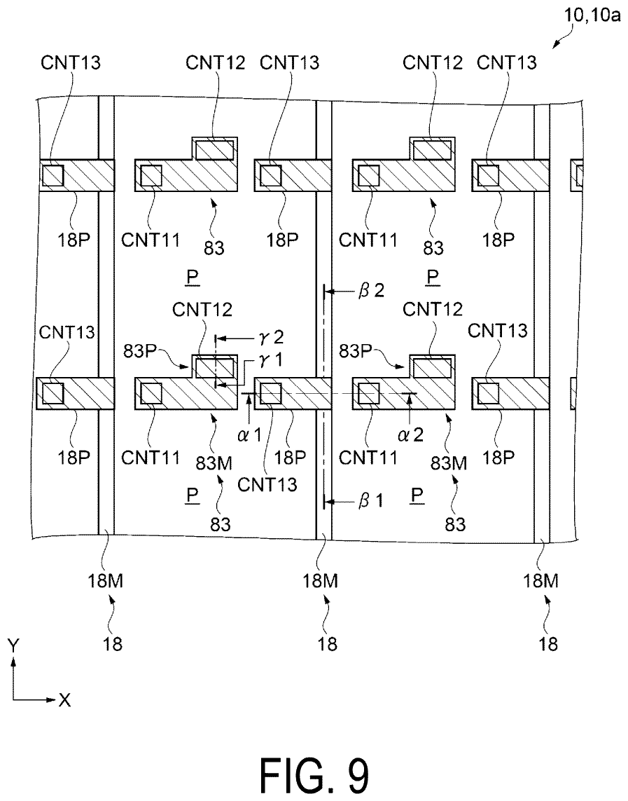

A liquid crystal device serving as an electro-optical device according to the present embodiment will be described with reference to FIGS. 9 to 11. A liquid crystal device according to a second embodiment is configured such that a region where a second layer 18b of a common wiring line 18 is provided is modified from the liquid crystal device 100 according to the embodiment described above. Thus, the same reference characters are used for the same constituent portions as those in the first embodiment, and explanation thereof will not be repeated.

FIG. 9 is a plan view illustrating a mode of a third relay electrode according to the second embodiment. FIG. 9 illustrates a region corresponding to FIG. 4, as in FIG. 8. Additionally, in the common wiring line 18, a region to which a stacked structure of a first layer 18a, the second layer 18b, and a third layer 18c is applied is indicated by hatching. Similarly, in a third relay electrode 83, a region to which a stacked structure of a first layer 83a, a second layer 83b, and a third layer 83c is applied is indicated by hatching.

As illustrated in FIG. 9, the second layer 18b and the third layer 18c are not provided in at least a portion of a main body portion 18M. That is, in the present embodiment, the second layer 18b and the third layer 18c are provided along the X-axis in plan view in the entire region of a protruding portion 18P and a portion of the region of the main body portion 18M.

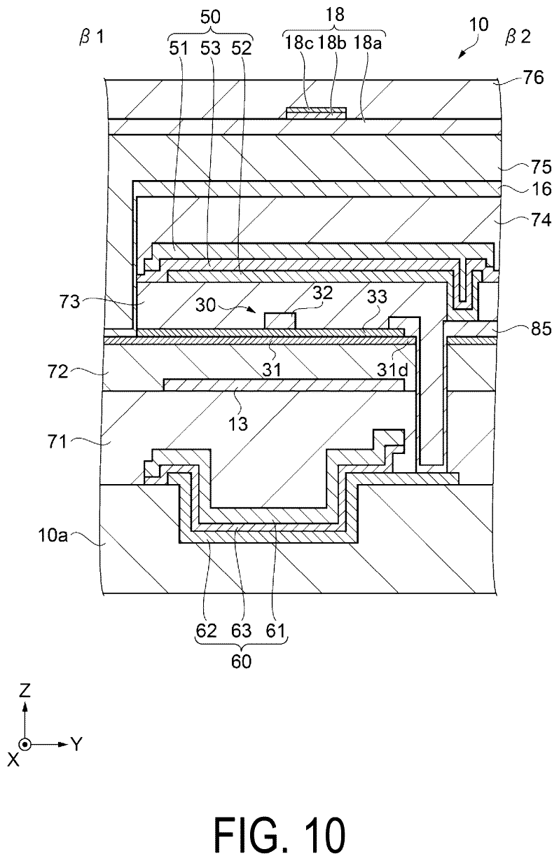

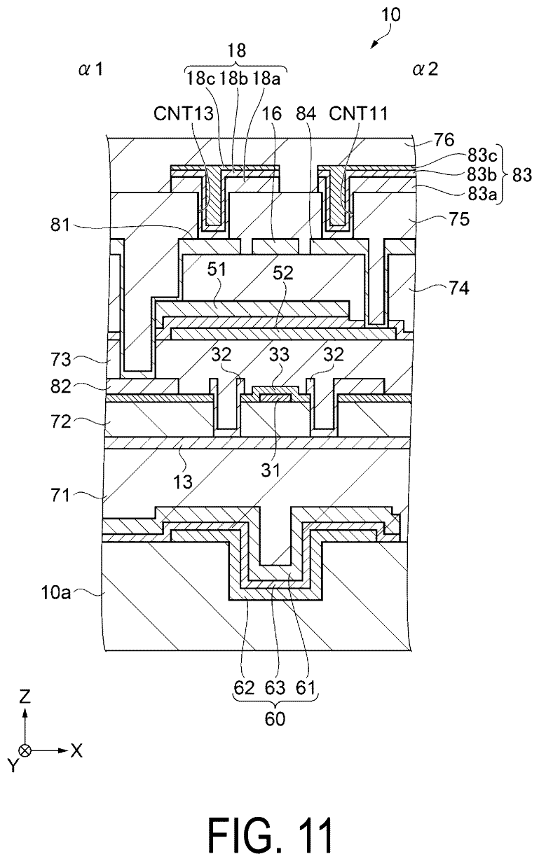

FIG. 10 is a cross-sectional view illustrating a structure of an element substrate in a line segment β1-β2 in FIG. 4. FIG. 11 is a cross-sectional view illustrating a structure of an element substrate in a line segment α1-α2 in FIG. 4.

More specifically, as illustrated in FIG. 10, the second layer 18b and the third layer 18c are stacked at a portion of the first layer 18a in the cross-section of the line segment β1-β2. FIG. 10 illustrates a region corresponding to FIG. 5. In addition, as illustrated in FIG. 11, the entire region of the first layer 18a is covered with the second layer 18b and the third layer 18c in the cross-section of the line segment α1-α2. FIG. 11 illustrates a region corresponding to FIG. 6.

The arrangement described above is preferable when the distance between adjacent common wiring lines 18 along the X-axis is relatively narrow. That is, since the above-mentioned distance is relatively narrow, the areas of the second layer 18b and the third layer 18c can be made relatively large around a third contact hole CNT13, and thus it is possible to exhibit a function of improving light reflectance by the third layer 18c while sufficiently exhibiting a function of curbing electrolytic corrosion and oxidation by the second layer 18b.

With the present embodiment, it is possible to obtain the effects similar to those of the embodiment described above.

In this embodiment, as shown in FIG. 11, the third relay electrode 83 is configured such that the first layer 83a and the second layer 83b are provided along the inner surface of a first contact hole CNT11, and the third layer 83c fills the first contact hole CNT11. Thereby, the third layer 83c can flatten a recess caused by the first contact hole CNT11. Thus, the film formation process is facilitated when manufacturing the layer above the first contact hole CNT11.

Furthermore, the common wiring line 18 is configured such that the first layer 18a and the second layer 18b are provided along the inner surface of a third contact hole CNT13, and the third layer 18c fills the third contact hole CNT13. Thereby, the third layer 18c can flatten a recess caused by the third contact hole CNT13. Thus, the film formation process is facilitated when manufacturing the layer above the third contact hole CNT13.

### Third Embodiment

The present embodiment describes, as an example, a projection-type display device 1000 as an electronic apparatus. The liquid crystal device 100 serving as the electro-optical device according to the embodiments described above is mounted at the projection-type display device 1000 according to the present embodiment. The projection-type display device 1000 is a liquid crystal projector.

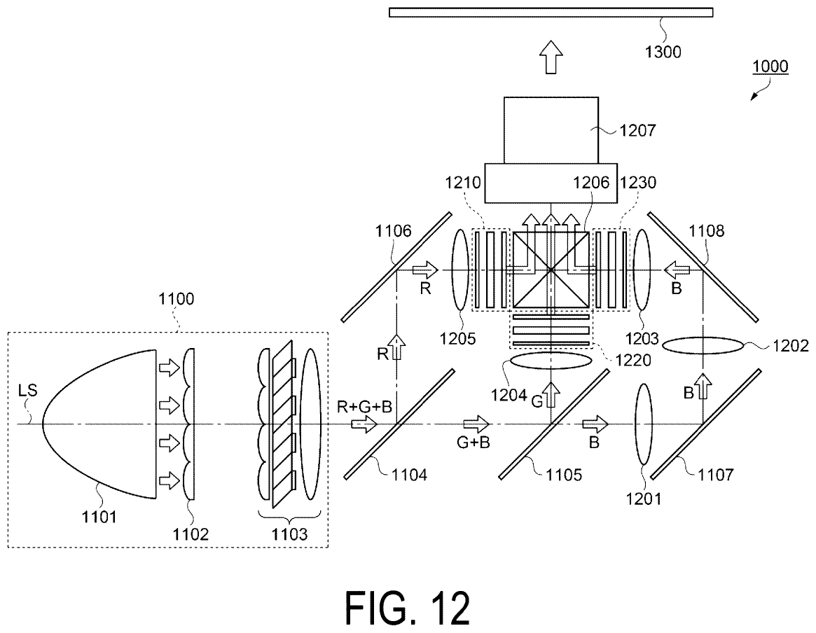

FIG. 12 is a schematic view illustrating a configuration of a projection-type display device according to a third embodiment.

As illustrated in FIG. 12, the projection-type display device 1000 includes: a polarized-light illumination device 1100 disposed along a system optical axis LS; two dichroic mirrors 1104 and 1105 serving as a light splitting element; three reflecting mirrors 1106, 1107, and 1108; five relay lenses 1201, 1202, 1203, 1204, and 1205; transmissive-type liquid-crystal light valves 1210, 1220, and 1230 serving as three optical modulation elements; a cross dichroic prism 1206 serving as a light synthesizing element; and a projection lens 1207.

The polarized-light illumination device 1100 generally includes a lamp unit 1101 being as a light source including a white light source such as an extra-high pressure mercury lamp or a halogen lamp, an integrator lens 1102, and a polarization conversion element 1103.

The dichroic mirror 1104 reflects red light (R) of a polarized light flux emitted from the polarized-light illumination device 1100, and allows green light (G) and blue light (B) to pass through. The other dichroic mirror 1105 reflects the green light (G) passing through the dichroic mirror 1104, and allows the blue light (B) to pass through.

The red light (R) reflected by the dichroic mirror 1104 is reflected by the reflection mirror 1106 and is then incident on the liquid-crystal light valve 1210 via the relay lens 1205. The green light (G) reflected by the dichroic mirror 1105 is incident on the liquid-crystal light valve 1220 via the relay lens 1204. The blue light (B) transmitted by the dichroic mirror 1105 is incident on the liquid crystal light valve 1230 via a light guide system including the three relay lenses 1201, 1202, and 1203 and the two reflection mirrors 1107 and 1108.

The liquid-crystal light valves 1210, 1220, and 1230 are each disposed to be opposed to a corresponding incident surface of each type of color light of the cross dichroic prism 1206. The color light that is incident on the liquid-crystal light valves 1210, 1220, and 1230 is modulated on the basis of image information (image signal), and is output toward the cross dichroic prism 1206.

In the cross dichroic prism 1206, four right-angle prisms are bonded together, and on inner surfaces of the prisms, a dielectric multilayer film configured to reflect the red light and a dielectric multilayer film configured to reflect the blue light are disposed in a cross shape. The three types of color light are synthesized by these dielectric multilayer films to obtain light representing a color image. The thus obtained light is projected onto a screen 1300 through the projection lens 1207 serving as a projection optical system, and an image is enlarged to be displayed.

The liquid crystal device 100 described above is applied to the liquid-crystal light valves 1210. The same applies to the other liquid-crystal light valves 1220 and 1230.

The projection-type display device 1000 as described above includes the liquid crystal device 100 according to the first embodiment. This makes it possible to improve the reliability of electrical coupling in a region including the first contact hole CNT11, the second contact hole CNT12, and the third contact hole CNT13 of the element substrate 10. Furthermore, it is possible to curb generation of heat within the element substrate 10. It is possible to obtain the similar effects by employing the liquid crystal device according to the second embodiment as the liquid-crystal light valves 1210, 1220, and 1230.

In addition to the projection-type display device 1000, the liquid crystal device 100 may be mounted on various types of electronic apparatuses such as an electrical view finder (EVF), a mobile mini-projector, a head-up display, a smartphone, a mobile phone, a mobile computer, a digital camera, a digital video camera, a display, a vehicle-mounted unit, an audio unit, a light exposure device, or an illumination unit.

The technical scope of the present disclosure is not limited to the above-described embodiments, and various modifications can be made without departing from the spirit and gist of the present disclosure. In addition, one aspect of the present disclosure can be configured by appropriately combining the characteristic portions of the above-described embodiments.

### Overview of Present Disclosure

An overview of the present disclosure is provided below as the appendices.

### Appendix 1

An electro-optical device including:
a pixel electrode;
a first wiring line including a first layer, a second layer, and a third layer;
a transistor at least partially overlapping the first wiring line in plan view; and
a data line provided in a layer between the first wiring line and the transistor, at least a portion of the data line overlapping the first wiring line in plan view, and electrically coupled to the pixel electrode via the transistor, wherein
the first layer has light reflectance and is disposed closer to the transistor than the second layer and the third layer,
the second layer is provided between the first layer and the third layer and has light reflectance lower than the first layer, and
the third layer has light reflectance higher than the second layer.

According to the electro-optical device having the configuration of Appendix 1, the third layer covering the outermost surface of the first wiring line easily reflects light, and thus it is possible to curb head generation due to absorption of light by the first wiring line. Thus, according to this configuration, it is possible to provide the electro-optical device in which heat generation is curbed.

### Appendix 2

The electro-optical device according to Appendix 1, further including a relay layer including a first main body portion provided in the same layer as the first wiring line, extending along a first direction, and electrically coupled to the transistor via a first contact hole, and a first protruding portion protruding from the first main body portion in a second direction intersecting the first direction, and electrically coupled to the pixel electrode via a second contact hole,
wherein the relay layer includes the first layer, the second layer, and the third layer.

According to the configuration of Appendix 2, it is possible to configure the relay layer that electrically couples the transistor and the pixel electrode with a stacked structure of the first layer, the second layer, and the third layer.

### Appendix 3

The electro-optical device according to Appendix 2, wherein at least the first layer and the second layer of the relay layer are provided along an inner surface of the first contact hole.

According to the configuration of Appendix 3, the first layer provided in the second contact hole is covered with the second layer, and thus it is possible to curb etching of the first layer in the second contact hole during patterning of the relay layer.

### Appendix 4

The electro-optical device according to Appendix 3, wherein the third layer of the relay layer flattens a recess caused by the second contact hole.

According to the configuration of Appendix 4, a film forming process is facilitated when manufacturing a layer above the second contact hole.

### Appendix 5

The electro-optical device according to any one of Appendices 2 to 4, further including a second wiring line adjacent to the first wiring line,
wherein the relay layer is provided between the first wiring line and the second wiring line when seen in plan view.

According to the configuration of Appendix 5, the first wiring line and the second wiring line can be disposed in a state of being separated from the relay layer.

### Appendix 6

The electro-optical device according to any one of Appendices 2 to 4, wherein the first wiring line includes a second main body portion extending along the second direction, and a second protruding portion protruding from the second main body portion in the first direction and electrically coupled to a capacitance element provided corresponding to the pixel electrode via a third contact hole.

According to the configuration of Appendix 6, it is possible to achieve a configuration in which the first wiring line and the capacitance element provided corresponding to the pixel electrode are electrically coupled to each other.

### Appendix 7

The electro-optical device according to Appendix 6, wherein at least the first layer and the second layer of the first wiring line are provided along an inner surface of the third contact hole.

According to the configuration of Appendix 7, the first layer provided in the third contact hole is covered with the second layer, and thus it is possible to curb etching of the first layer in the third contact hole during patterning of the first wiring line.

### Appendix 8

The electro-optical device according to Appendix 7, wherein the third layer of the first wiring line flattens a recess caused by the third contact hole.

According to the configuration of Appendix 8, a film forming process is facilitated when manufacturing a layer above the third contact hole.

### Appendix 9

The electro-optical device according to any one of Appendices 6 to 8, wherein the second layer and the third layer are not provided in at least a portion of the second main body portion of the first wiring line.

According to the configuration of Appendix 9, the first layer is exposed on the surface of the main body portion, and thus it is possible to increase light reflectance of the second main body portion to efficiently curb heat generation due to light absorption of the first wiring line.

### Appendix 10

The electro-optical device according to any one of Appendices 6 to 9, wherein, in the second protruding portion of the first wiring line, the second layer and the third layer are not provided at a portion of the first wiring line on the main body portion side.

According to the configuration of Appendix 10, even when the areas of the second and third layers are relatively small around the third contact hole, the functions of the second and third layers are sufficiently exhibited.

### Appendix 11

The electro-optical device according to any one of Appendices 6 to 9, wherein the second layer and the third layer are provided along the first direction at portions of the second protruding portion of the first wiring line and the second main body portion of the first wiring line.

According to the configuration of Appendix 11, the surplus second and third layers are reduced around the third contact hole. For this reason, it is possible to increase light reflectance by increasing the region where the first layer is exposed while improving the reliability of electrical coupling around the third contact hole.

### Appendix 12

The electro-optical device according to any one of Appendices 1 to 11, wherein
the first layer contains aluminum,
the second layer contains titanium nitride, and
the third layer contains titanium.

According to the configuration of Appendix 12, the first wiring line can be configured with a stacked structure of aluminum, titanium nitride, and titanium. For this reason, the first wiring line can reflect light by titanium covering the outermost surface, and thus it is possible to efficiently curb heat generation due to light absorption.

### Appendix 13

The electro-optical device according to any one of Appendices 1 to 4, wherein a constant potential is applied to the first wiring line.

According to the configuration of Appendix 13, it is possible to curb heat generation of the first wiring line to which a constant potential is applied.

### Appendix 14

An electronic apparatus including the electro-optical device according to any one of Appendices 1 to 13.

According to the electronic apparatus having the configuration of Appendix 14, the electro-optical device in which heat generation inside the substrate is curbed is provided, and thus it is possible to provide the electronic apparatus in which heat generation is curbed.

What is claimed is:

1. An electro-optical device comprising:
a pixel electrode;
a first wiring line including a first layer, a second layer, and a third layer;
a transistor at least partially overlapping the first wiring line in plan view; and
a data line provided at a layer between the first wiring line and the transistor, at least partially overlapping the first wiring line in plan view, and electrically coupled to the pixel electrode via the transistor, wherein
the first layer has light reflectance and is disposed closer to the transistor than the second layer and the third layer,
the second layer is provided between the first layer and the third layer and has light reflectance lower than the first layer, and
the third layer has light reflectance higher than the second layer.

2. The electro-optical device according to claim 1, further comprising a relay layer including a first main body portion provided at the same layer as the first wiring line, extending along a first direction, and electrically coupled to the transistor via a first contact hole, and a first protruding portion protruding from the first main body portion in a second direction intersecting the first direction, and electrically coupled to the pixel electrode via a second contact hole,
wherein the relay layer includes the first layer, the second layer, and the third layer.

3. The electro-optical device according to claim 2, wherein at least the first layer and the second layer of the relay layer are provided along an inner surface of the first contact hole.

4. The electro-optical device according to claim 3, wherein the third layer of the relay layer flattens a recess caused by the second contact hole.

5. The electro-optical device according to claim 2, further comprising a second wiring line adjacent to the first wiring line,
wherein the relay layer is provided between the first wiring line and the second wiring line when seen in plan view.

6. The electro-optical device according to claim 2, wherein the first wiring line includes a second main body portion extending along the second direction, and a second protruding portion protruding from the second main body portion in the first direction and electrically coupled to a capacitance element provided corresponding to the pixel electrode via a third contact hole.

7. The electro-optical device according to claim 6, wherein at least the first layer and the second layer of the first wiring line are provided along an inner surface of the third contact hole.

8. The electro-optical device according to claim 7, wherein the third layer of the first wiring line flattens a recess caused by the third contact hole.

9. The electro-optical device according to claim 6, wherein the second layer and the third layer are not provided at at least a portion of the second main body portion of the first wiring line.

10. The electro-optical device according to claim 6, wherein, in the second protruding portion of the first wiring line, the second layer and the third layer are not provided at a portion, on the main body portion side, of the first wiring line.

11. The electro-optical device according to claim 6, wherein the second layer and the third layer are provided along the first direction and at portions of the second protruding portion of the first wiring line and the second main body portion of the first wiring line.

12. The electro-optical device according to claim 1, wherein
the first layer contains aluminum,
the second layer contains titanium nitride, and
the third layer contains titanium.

13. The electro-optical device according to claim 1, wherein a constant potential is applied to the first wiring line.

14. An electronic apparatus comprising the electro-optical device according to claim 1.
